(19) United States
(12) Patent Application Publication
(10) Pub. No.: US 2016/0227751 A1
(43) Pub. Date: Aug. 11, 2016

(54) FISHING TACKLE ATTACHMENT APPARATUS AND METHOD

(71) Applicant: Global Manufacturing Supplies Ltd, Prudhoe (GB)

(72) Inventor: Andrew Petherick, Alnwick (GB)

(21) Appl. No.: 15/132,992

(22) Filed: Apr. 19, 2016

Related U.S. Application Data
(62) Division of application No. 13/518,262, filed on Aug. 6, 2012.

(30) Foreign Application Priority Data
Dec. 21, 2009 (GB) 0922232.4
Jun. 22, 2010 (GB) 1010470.1

(51) Int. Cl. A01K 91/04

(52) U.S. Cl. CPC A01K 91/04

(57) ABSTRACT

An item of fishing tackle comprising a compressible connector adapted to attach said item of fishing tackle to a fishing line, wherein the compressible connector comprises a wall defining an elongate cavity having an opening at one end thereof, the cavity being adapted to receive a portion of fishing line through the opening, and wherein the wall is adapted to be compressed inelastically towards the portion of fishing line inserted into the cavity to secure the said portion of line therein.

### CROSS-REFERENCE TO RELATED APPLICATIONS

This application is a divisional of U.S. patent application Ser. No. 13/518,262, filed Aug. 6, 2012, entitled FISHING TACKLE ATTACHMENT APPARATUS AND METHOD, which is a 371 National Stage Application of International Application No. PCT/GB2010/052147, filed Dec. 20, 2010, entitled FISHING TACKLE ATTACHMENT APPARATUS AND METHOD, which claims priority to Great Britain Patent Application No. 1010470.1, filed Jun. 22, 2010, and to Great Britain Patent Application No. 0922232.4, filed Dec. 21, 2009, the entire content of each of which is incorporated herein by reference.

### BACKGROUND

1. Technical Field

The present invention relates to fishing tackle and in particular to a fishing tackle attachment apparatus. The apparatus attaches an item of fishing tackle to fishing line.

2. The Relevant Technology and Brief Summary

Since man started fishing he has had to consider how to attach a fishing hook to fishing line. Whilst many different methods have been employed, the most commonly used is to provide the fishing hook with an eye through which the line is passed. A knot is then tied in the line to secure the hook to the line. Other methods include simply whipping the line onto the shank of the hook. The shank of the hook may include a splayed end or not. Attaching the hook to the line using these latter techniques requires considerable skill, experience and knowledge otherwise the hook is likely to be pulled off the line.

The use of knots to attach a hook to line presents a number of challenges. First, the act of tying a knot in line often weakens the line. Hence, a fisherman may think that he is using the appropriate strength of line for the type of fishing he is undertaking, but if tying a knot in the line reduces the line's strength by 50% (which is not unusual in a poorly tied knot) his line may be too weak. If the fisherman has tied a number of knots in his line, for example to either end of a swivel, his rig may contain a number of weak points. Second, from the perspective of catching fish, it is desirable that the line should be as unobtrusive as possible, i.e. as thin as possible. However, in order to be able to tie a knot effectively in a length of fishing line, it is necessary for the line to have a certain thickness.

Also, the fact that fishing line is expected to be knotted, places a compromise on the manufacture of the line in that the fishing line is subjected to a drawing process which increases its strength, but there is a point beyond which further drawing, while continuing to increase the linear strength of the line, reduces the knot strength of that line. A number of suggestions have been put forward regarding how knots may be dispensed with. These typically involve a collar through which the line is passed, the line then being passed through the eye of the hook or swivel and back through the collar, which is then compressed on to the line, thereby holding the item of fishing tackle in place.

This type of apparatus is exemplified in the published patent documents referred to below:

U.S. Pat. No. 1,156,152 describes a fishing hook having a corrugated shank with a flattened end. An aluminium tube is fastened to the shank as a clamp. A line is fastened by the clamp, the line having a knot at one end to prevent it from being pulled out of the clamp.

US2003/0182844 seeks to overcome the problem of having to thread a line and knot it and describes a fishing hook having a locking tube and locking arm. Line is wrapped around the shank under the locking arm and the locking tube is slid over the arm to press it down holding the line in position. US2007/0227059 describes a crimpable collar comprising a metal outer part and an inner part made of compressible material. In use line is passed through the collar, through the eye of an item of fishing tackle, such as a hook or swivel, and back through the collar, whereupon the collar is crimped, the action of crimping exerting such a force on the compressible material that the friction force generated between the compressible material is sufficient to hold the item of tackle on the line.

However, none of the apparatus described above get over the other well known problem that affects fishing hooks, swivels and the like. Many fishermen find it very difficult to thread fishing line through the eye of the hook, swivel or the like. This operation requires a high degree of accuracy which is made particularly difficult for a fisherman with poor eyesight and when fishing offshore and the fishing vessel is listing in a swell, for example. Considering a hook, the hook must be held in the fingers of one hand whilst the line is held in the fingers of the other hand. When the weather is cold, the threading of line through the eye of a hook can be very difficult. The fisherman is likely to be wearing gloves and therefore must either hold the hook and line in gloved hands, or remove his gloves in which case his fingers may quickly become so cold that he is not able to manipulate the hook and line as is required. Furthermore, considerable knowledge of knot tying is also required to successfully secure a line to a hook or other item of fishing tackle. It would therefore be desirable to provide an alternative means of attaching fishing line to an item of fishing tackle.

It would also be desirable to provide a fishing hook including such alternative means of attaching fishing line thereto.

It would also be desirable to provide a swivel including such alternative means of attaching fishing line thereto.

It would also be desirable to provide a connector for connecting together two pieces of fishing line of the same or different diameters. According to a first aspect of the present invention there is provided an item of fishing tackle comprising a compressible connector adapted to attach said item of fishing tackle to a fishing line, wherein the compressible connector comprises a wall defining an elongate cavity having an opening at one end thereof, the cavity being adapted to receive a portion of fishing line through the opening, and wherein the wall is adapted to be compressed inelastically towards the portion of fishing line inserted into the cavity to secure the said portion of line therein.

It will be understood that an item of fishing tackle may comprise a hook, a swivel, a line connector, or similar item used for fishing which is attachable to fishing line to form a rig. ‘Fishing line’ when referred to herein shall be taken to include any one or more of, or chemical composition of, mono- and/or multi-filament or derivatives thereof, braid, wire and fluorocarbon. Whilst this list could be exhaustive, the term ‘fishing line’ has been chosen to denote the connective material between the angler and the fish.

Preferably the connector is compressed a predetermined distance towards the portion of fishing line. Further preferably the connector is compressed a predetermined amount to engage the fishing line and to compress the fishing line a predetermined amount without compromising its integrity. Although the cross section of the portion of fishing line secured in the connector may change during compression, its cross sectional area preferably remains unchanged. This ensures the tensile strength of the line is not compromised and remains constant whereas the frictional force between the line and the connector wall increases with increased compression of the connector and line. Preferably the elongate cavity has an opening at each end thereof. This allows an end portion of fishing line to pass through the connector and extend a desired distance from the connector. Therefore, the connector may be attached to an end portion of fishing line or the end portion of line may extend a desired distance from the connector. This also desirably allows multiple connectors to be attached to a single piece of line making them ideal for rig manufacture and multi-link terminal tackle set ups, which is particularly desirable to lure anglers as the small solid eye is suitable for attaching lures that feature split rings. Having an opening at each end of the cavity also allows for the line to be passed across the back of a hook shank, where the item of fishing tackle is or includes a hook, so that a ‘hair’ can be made. Furthermore, more than one hook may connect to a single connector.

Alternatively, one end of the cavity may be closed allowing for an end portion of line to be inserted into the open end of the cavity. This provides for axial alignment of the line with the item of fishing tackle and also allows the size of the item of fishing tackle to be kept to a minimum. The item can be kept slender in shape which desirably reduces the risk of snagging on weed for example. The need to pass an end portion of line through the cavity of the connector, through a hook eye for example, and back into the cavity to crimp two portions of the line together, as is the case with known devices, is avoided which otherwise can undesirably result in adverse frictional affects and misalignment between the line portions.

Preferably the compressible connector is substantially tubular. When referring to tubular, this shall be taken to include tubes formed such that the cross-section is continuous and/or discontinuous and having any shape of cross section, such as circular, in an uncompressed state. For example, a tube in which the wall has a discontinuous cross-section the ends of the wall of the tube may meet, almost meet or overlap. Preferably the connector is circular in cross section. This ensures the connector is slender in shape to minimise the risk of weed or line, or similar, snagging thereon and to ensure the item of fishing tackle performs well through water and air without causing unnecessary turbulence. Preferably the cavity has an inner diameter which is sized according to the diameter of the line being inserted therein. Further preferably the cavity diameter is only slightly larger than the line diameter to allow for ease of insertion but minimum movement therebetween before compression of the wall.

Suitably at least the inner surface of the cavity wall may be substantially smooth to the eye, i.e. scoring or similar is not essential to sufficiently grip the line when in a compressed configuration, particularly as such scoring or similar may undesirably subject the line to point forces and compromise its integrity.

Suitably the wall of the compressible connector is formed of a metal.

Preferably the wall of the connector is steel and more preferably the wall of the connector is stainless steel. Suitably the steel is tempered or annealed to ensure it is soft and uniform enough to be inelastically compressed consistently to secure the line in the connector.

Suitably the item of fishing tackle may further comprise a force distribution element adapted to distribute lateral forces exerted on the line by the connector in the region of the opening. The element protects the line from the connector wall and particularly in the region of the opening which could be sharp and compromise the integrity of the line, particularly when subjected to non-axial tensile loading. Suitably the force distribution element may comprise a radius on or at the edge of the wall presented at the opening. Although not essential to the aligned security of the line in the connector, the force distribution element may comprise a bush of an elastically compressible material, such as soft thermoplastics, rubbers or metals, for example. The bush may comprise an end portion which extends fully or partially over the edge of the wall presented at an opening of the cavity thereby to protect the line therefrom. Suitably the bush may sit internally or externally of wall. A part of the bush may extend beyond the end of the opening of the cavity. Alternatively, a bush may not be required and the edge of the wall presented at the opening may be suitably shaped, e.g. swaged, to form a radius at the edge of the wall to protect the line from non-axial tensile loading.

The item of fishing tackle may be a hook, and wherein the wall comprises the shank of the hook and wherein the opening is situated at one end of the wall and a bend extends from the other end of the shank. Furthermore, one of the shank and the bend may include a spigot and the other may include a spigot receiving portion, and wherein the bend is secured to the shank by inserting the spigot into the spigot receiving portion. The spigot and spigot receiving portion may include correspondingly shaped elements configured to restrict relative movement between said spigot and spigot receiving portion. For example, the spigot and spigot receiving portion may be hexagonal in cross section to engage correspondingly together. Preferably, the spigot and spigot receiving portion are circular in cross section.

Alternatively, where the compressible connector has two open ends, one end is adapted to engage over the shank of a hook, or similar elongate portion of an item of fishing tackle, and attach securely to the hook and form a shank portion thereof. The end of fishing line may then be inserted into the other open end of the connector and the connector compressed to secure the line the hook. A suitable means of attaching the connector to the hook is by mechanically pressing the connector onto the shank having an interference fit therebetween. A conventional hook may be modified by removing the eye to form a shank having a free end on which the compressible connector may attach. Suitably a mild steel connector is more malleable than a hardened steel hook to allow the connector to be pressed securely over the shank of a hardened steel hook, for example. Alternatively, the said item of fishing tackle may be a swivel and comprise at least one compressible connector and at least one element rotatable with respect to the connector. The swivel may comprise two compressible connectors attached together by at least one element permitting relative rotation between two said compressible connectors. The at least one element permitting relative rotation between two said compressible connectors may be a swivel body.

Alternatively, the said item of fishing tackle may be a line connector and comprise a compressible connector having two open ends, line being insertable into each open end. The line connector may further comprise a first cavity extending from one end of the connector and a second cavity extending from the other end of the connector. The first and second cavities allow for end portions of different line to be separately secured and spaced apart to the connector without interfering each other. The cavities are coaxial so lines secured therein are axially aligned for maximum performance when subjected to a load in use. The lines are suitably separated and do not overlap or engage each other to ensure said alignment is consistently achieved and to prevent adverse frictional affects therebetween. Suitably the first cavity may be of a first internal diameter and the second cavity may be of a second internal diameter. This allows two lines of different sizes to be connected together in an aligned manner.

Alternatively, the said item of fishing tackle may be a connector, the item of fishing tackle further comprising an attachment element for the attachment of another item of fishing tackle thereto. Suitably the said attachment element may be situated to one end of the connector. The attachment element may for example be one of an eye, a clip, a wire, a loop, a ring and a snap shackle.

According to a further aspect of the invention there is provided a combination of such a connector and another item of fishing tackle, such as a hook. According to a further aspect of the invention there is provided a tool adapted to compress the wall of the compressible connector of an item of fishing tackle as described above onto a portion of fishing line.

Advantageously, the tool allows for quick, simple and consistent attachment of a portion of fishing line to an item of fishing tackle in accordance with the present invention. The tool comprises a pair of jaws and is configured such that when the jaws are in a closed configuration there exists a gap between opposing faces of the jaws. The gap between the jaws when in a closed configuration after the connector has been compressed on to the line inserted therein is important to the performance of the line/connector. Over compressing the connector may compromise the integrity of the line and under compressing may result in slippage of the line in the connector. The gap size may be selected depending on the diameter and/or type of line being attached to the item of fishing tackle. For example, the tool may comprise means to selectively adjust the gap size and/or a pair of jaws may be selected from an array of jaws depending on the gap size required when the jaws are in a closed configuration.

The tool is configured to compress a connector a predetermined distance towards the portion of fishing line to secure the same thereon with a high level of accuracy and control. The connector is desirably compressed a predetermined amount to engage the fishing line and to compress the fishing line a predetermined amount without compromising its integrity. Importantly, although the cross section of the portion of fishing line secured in the connector may change during compression, its cross sectional area remains unchanged. This ensures the tensile strength of the line is not compromised and remains constant whereas the frictional force between the line and the connector wall increases with increased compression of the connector and line.

Preferably each jaw comprises a plurality of different sized corresponding grooves which are sized according to the diameter of line and/or item of fishing tackle. Suitably at least one of the jaws may comprise gripping means to grip an item of fishing tackle placed in said jaw before and during the compression operation. The gripping means may define a gripping portion of the jaws which is made from a different material thereto having a high coefficient of friction relative to the material of the jaws. The gripping portion may be a rubber or plastics material.

Preferably the tool further comprises means to ensure the correct clamping force is applied during every clamping operation. This advantageously provides consistency for every clamping operation. Such means may be audible or visual. An example of an audible means may be a ratchet mechanism. Suitably, the clamping force applied to the compressible connector of an item of fishing tackle according to the present invention may be selectively controlled. This may be alternative to or in addition to selectively adjusting the gap between the jaws when in the closed position.

The tool may comprise means to feed an end of a line into the cavity of the compressible connector of an item of fishing tackle. This would allow for line to be inserted and secured to the connector of the item of fishing tackle in accordance with the present invention is an easy and quick manner even in cold adverse weather conditions and/or where the angler is wearing gloves which would otherwise make such an operation particularly difficult. An item of fishing tackle, such as a hook, may be manually loaded into the tool and the end of fishing line offered up to the tool. In a first operation, the end of the line may be gripped by the tool and fed into the compressible connector of the hook by operation of the tool. In a second operation, the compressible connector is compressed by the tool to secure the hook on the line. The tool may further comprise means to automatically load an item of fishing tackle in accordance with the present invention into the jaws for attaching to a line. Such means may comprise a magazine for containing a plurality of items of fishing tackle for loading into the tool and attaching to a line in quick succession. Items of fishing tackle, such as a plurality of similar hooks in accordance with the present invention, may be adhered together for placement in the magazine, the adhesion between adjacent hooks being suitably compromised when a hook is automatically loaded into the tool. An array of detachable and differently sized jaws may be provided and a pair of jaws may be selected from the array according to the diameter of line being connected to the item of fishing tackle being clamped and/or the length of compression area required. A pair of jaws may be selected in accordance with the desired gap size when the jaws are in a closed configuration. Desirably, each pair of differently sized jaws may be colour-coded and/or labelled according to a line size/type for the angler's convenience. The colour coding may correspond to the colour coding on a reel of line such as monofilament and/or an item of fishing tackle.

Alternatively or additionally, a line gauge may be provided to enable the fisherman to select the correct groove or jaw size according to the line.

One or both of the jaws may include a lanyard hole. The tool may further comprise means for cutting a line.

Of course, the compression tool is not limited to a handheld tool and may be a piece of apparatus mounted to the ground or deck of a fishing vessel, for example. Such apparatus may be electrically or pneumatically operated and may be fully automated to provide an apparatus which is efficient, significantly increases productivity output and consistency, requires minimal operator training and reduces waste.

According to another aspect of the invention there is provided a method of attaching an item of fishing tackle in accordance with the present invention to a portion of line, comprising the steps of:
i) inserting a portion of fishing line into the cavity of the item of fishing tackle; and
ii) compressing the compressible wall thereof such that the item of fishing tackle is secured to the line. The method may comprise the further step of attaching another item of fishing tackle to the attachment element of a connector in accordance with the present invention.

According to a further aspect of the invention there is provided a method of attaching an item of fishing tackle according to the present invention to a fishing line using a tool as described above, comprising the steps of:
i) inserting at least one item of fishing tackle between the jaws of the tool;
ii) moving said jaws towards a closed position to hold the item of fishing tackle therebetween;
iii) inserting a fishing line into the cavity of the compressible connector;
iv) further moving said jaws towards the closed position to compress the compressible wall of the connector such that the item of fishing tackle is secured to the line; and
v) releasing the item of fishing tackle and line from the tool.

Preferably the at least one item of fishing tackle is placed in one of the jaws and the other jaw is moved towards the item of fishing tackle.

Preferably in the above methods the connector is compressed a predetermined distance towards the portion of fishing line. Further preferably the connector is compressed a predetermined amount to engage the fishing line and to compress the fishing line a predetermined amount without compromising its integrity. Importantly, although the cross section of the portion of fishing line secured in the connector may change during compression, its cross sectional area remains unchanged. This ensures the tensile strength of the line is not compromised and remains constant whereas the frictional force between the line and the connector wall increases with increased compression of the connector and line.

Suitably one or both of the above methods may comprise the step of providing an adhesive to adhere the line in the cavity. A suitable adhesive may be cyanoacrylate glue or a two-part epoxy resin. However, the main advantage of the present invention is the knotless method of joining an item of fishing tackle to fishing line without the aid of adhesive and which has been shown to be stronger than a knot and as strong as the line itself, as described below.

According to a further aspect of the invention there is provided a kit of parts comprising an item of fishing tackle and a tool in accordance with the present invention.

These and other objects and features of the present invention will become more fully apparent from the following description and appended claims, or may be learned by the practice of the invention as set forth hereinafter.

### BRIEF DESCRIPTION OF THE DRAWINGS

Preferred embodiments of the present invention will now be described, by way of example only, with reference to the accompanying drawings, of which:

FIG. 1 shows a non-compressed empty tube;

FIG. 2 shows a non-compressed tube with line inserted therein;

FIG. 3 shows a compressed tube with line in;

FIG. 4 shows a compressed tube with line inserted therein, the line having a stopper knot;

FIG. 5 shows a compressed tube with line inserted therein, the line having a stopper;

FIG. 6 shows a compressed tube with line inserted therein, the line having a stopper;

FIGS. 7a to 7e illustrate different possible ways of compressing the tube;

FIG. 8 illustrates a tube in cross-section;

FIG. 9a illustrates a tube having an internal bush;

FIG. 9b illustrates a tube having an external bush;

FIGS. 10a to 10g illustrate a procedure for testing the strength of a fishing tackle comprising line and a device according to the invention;

FIG. 11 is a schematic representation of a swivel of the prior art;

FIG. 12 is a schematic representation of one embodiment of a swivel according to the invention;

FIG. 13 is a schematic representation of second embodiment of a swivel according to the invention;

FIG. 14 is a schematic representation of a third embodiment of a swivel according to the invention;

FIG. 14b is a schematic representation of a fourth embodiment of a swivel according to the invention;

FIG. 14c is a schematic representation of a fifth embodiment of a swivel according to the invention;

FIG. 15 is a schematic representation of sixth embodiment of a swivel according to the invention;

FIG. 16 is a schematic representation of one embodiment of a connector according to the invention;

FIG. 17 is a schematic representation of a second embodiment of a connector according to the invention;

FIG. 17b is a schematic representation of a third embodiment of a connector according to the invention;

FIG. 18 is a schematic representation of a line connector according to the invention configured to connect together line of the same diameter;

FIG. 19 is a schematic representation of a line connector according to the invention configured to connect together line of different diameters;

FIG. 20 illustrates the line connector of FIG. 19 in cross-section;

FIG. 20b is a schematic representation of a line connector according to the invention including a swivel body;

FIG. 21 is a schematic representation of a tool for compressing a deformable portion of an item of fishing tackle according to the invention;

FIGS. 21a and 21b are schematic representations of a preferred embodiment of the tool of FIG. 21;

FIGS. 21c and 21d are schematic representations of a preferred embodiment of the jaws of the tool of FIG. 21;

FIG. 22 is a schematic representation of the bend part of a hook according to the invention;

FIG. 23 is a schematic representation of the shank part of a hook according to the invention;

FIG. 24 is a schematic representation of a spacer of a hook according to the invention;

FIG. 25 is a schematic representation of a piece of line for insertion into a hook according to the invention;

FIG. 26 is a schematic representation of an assembled hook according to the invention attached to a piece of fishing line;

FIG. 27 is a schematic cross-sectional elevation of a hook according to a second embodiment of the invention;

FIG. 28 is a schematic cross-sectional elevation of the hook illustrated in FIG. 27 with the line inserted therein;

FIG. 29 is a schematic representation of another embodiment of the invention;

FIG. 30 is a schematic representation of an adaptation of the embodiment illustrated in FIG. 29; and

FIG. 31 is an alternative schematic representation of the embodiment illustrated in FIG. 30.

### DETAILED DESCRIPTION

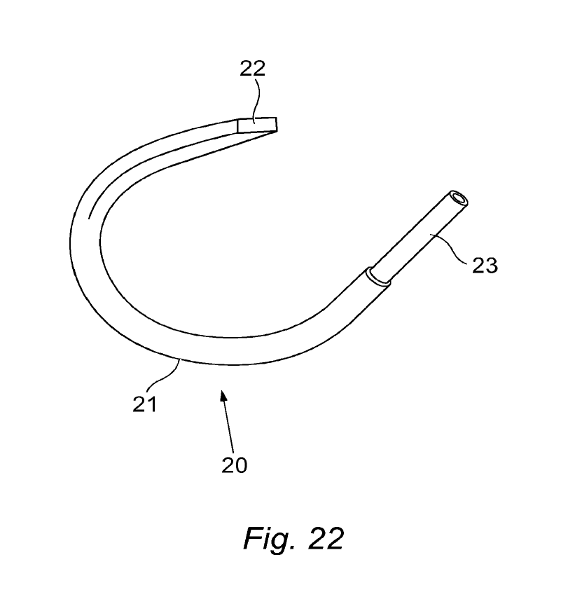

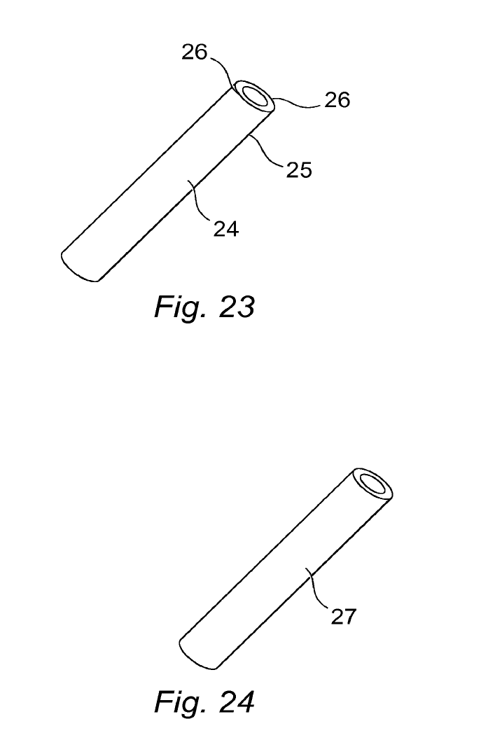

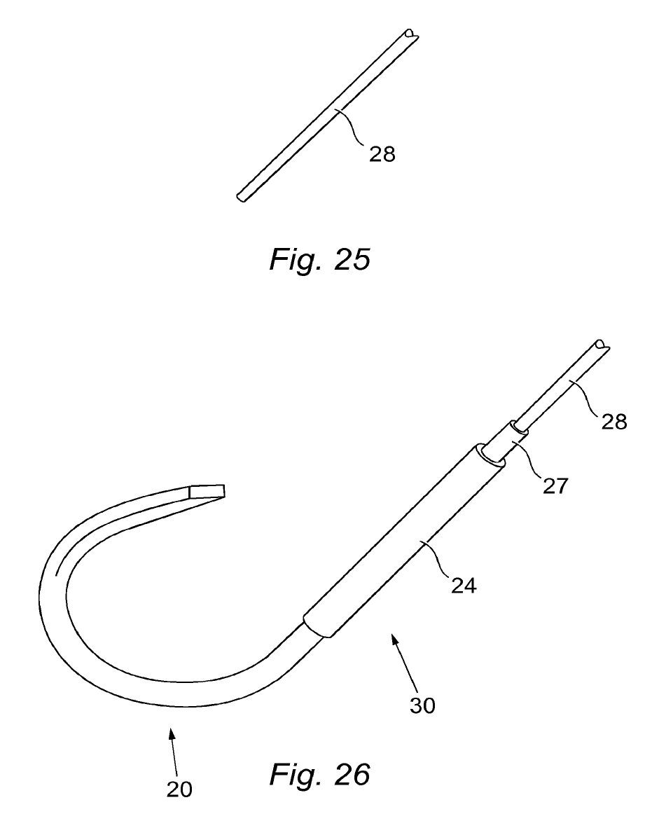

Referring first to FIGS. 22 to 26, there is shown a fishing hook according to the invention. The hook 30 comprises a number of parts: a bend 20 as illustrated in FIG. 22, a tubular shank 24 as illustrated in FIG. 23, and a bush 27 insertable into the tubular shank 24. An end of line 28 is inserted into the bush 27 and secured on the line by compressing the tubular shank 24.

The tubular shank 24 is stainless steel and the bush 27 is formed of plastics material. However, it has been found that the bush 27 may be a metal material such as aluminium for certain types of line, such as braid, because such a material possesses a higher coefficient of friction than steel and desirably provides an increased level of grip on specialist types of fishing line, such as braid.

The bush 27 is also used in this embodiment to protect the line 28 when a force is exerted on the line when the axis of the line 28 and the axis of the shank 24 of the hook are not aligned. When playing a fish it is not unusual for the axis of the line, other than the portion of line inserted in the shank, to lie perpendicular to the axis of the shank of the hook. It is therefore important that in such a scenario the line does not lie against a sharp edge, which would exert a significant point load on the line and could compromise its integrity.

Referring specifically to FIG. 22, the bend 20 includes a point 22 at one end of a curved section of material, typically metal, and at the other end a spigot 23, which in the example is substantially circular in cross section but which may be any suitable shape. The spigot 23 engages with the correspondingly shaped tubular shank 24 to form an interference fit therebetween. Any suitable joining technique may be used, such as welding or butt joining, to attach the spigot to the tubular shank. The tubular shank 24 is formed of a compressible inelastic material, such as tempered stainless steel, which is softer and more malleable than the hook which is typically hardened steel. Alternatively, the eye of an existing hook may be removed and a tubular shank may be pressed by interference fit, and/or other suitable joining technique, over the existing shank portion to provide a hook in accordance with the present invention.

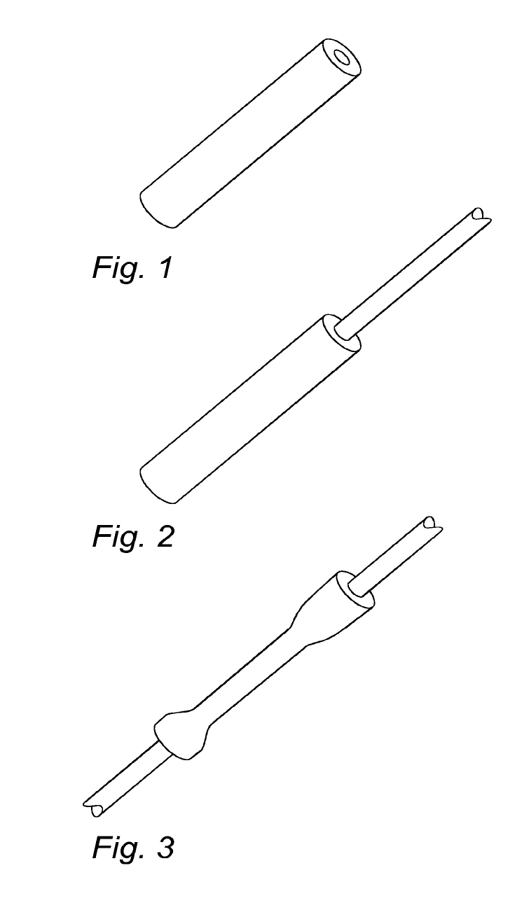

Referring now to FIGS. 1 to 3, there is illustrated a tube suitable for forming the deformable part of an item of fishing tackle. In FIG. 3, the tube is illustrated in a deformed condition, the thinner, deformed portion of the tube attaching the same to the line by compressing the wall of the tube against the outer surface of the line without compromising the line integrity. The deformed portion may take any form but preferably the deformed portion is circular in cross section or comprises at least two flat sides, as shown in FIG. 7e, to compress the line without compromising its integrity.

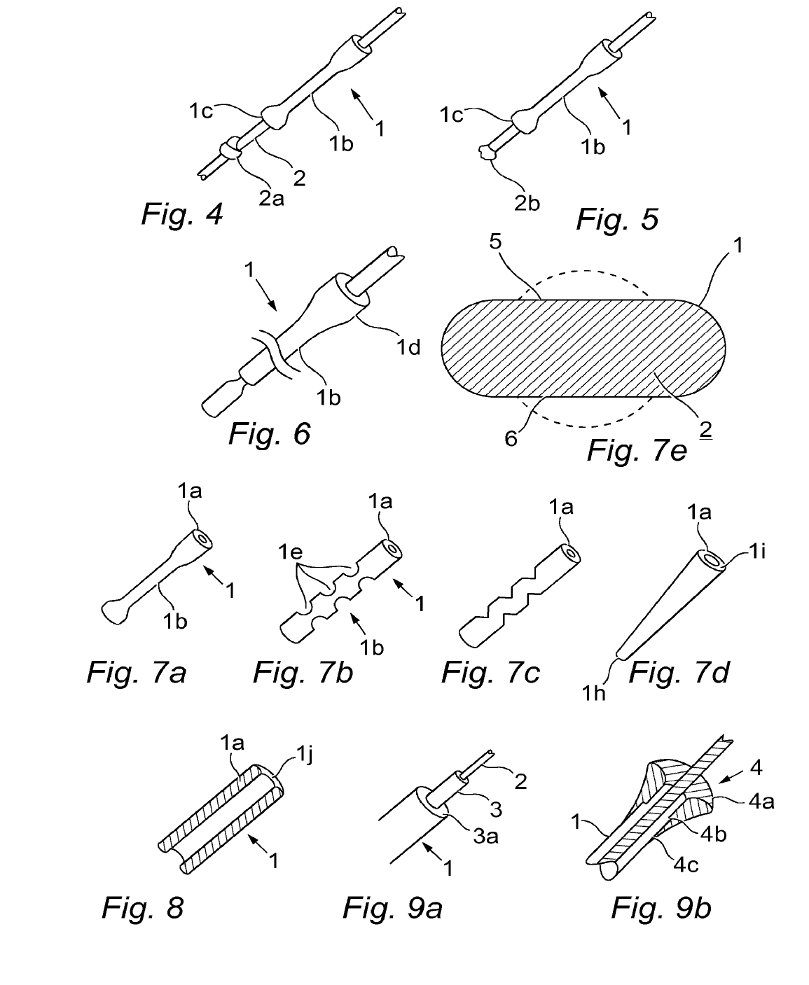

In FIG. 4, the line 2 includes a stopper created by tying a stopper knot 2a. The purpose of adding a stopper is to provide a back stop in the event that the force of the wall 1b of the tube 1 pressing on the line is overcome by the force exerted on the line, in which case the line would be pulled through the tube 1, until the end 1c of the tube is engaged by the stopper knot 2a.

In FIG. 5, the stopper 2b is formed by melting the line 2. The stopper 2b functions in the same manner as stopper 2a.

In FIG. 6, a stopper is formed in a different manner to that illustrated in FIGS. 4 and 5. In FIG. 6, the compressible portion 1b of the tube 1 is compressed to such an extent that the line 2 is compressed, and therefore the portion of line 2 in the uncompressed portion 1d is of a larger diameter than the section of line compressed by the compressed portion 1b of the tube 1. Such an arrangement provides the advantage that there is no requirement to tie a knot or melt the end of the line. However, over compressing the line may adversely affect the mechanical properties thereof and under compressing the tube may allow the line to slip therein.

FIGS. 7a to 7e illustrate different ways in which the portion 1b may be compressed.

In FIG. 7a the portion 1b is compressed in an even fashion over the portion 1b. The portion 1b squeezes the line 2 along the length of the portion 1b.

In FIG. 7b the compressed portion 1b is compressed at three different points 1e, the line 2 being gripped at the points 1e.

In FIG. 7c the compressed portion 1b is compressed at five different points, three points 1f on one side of the tube and two points 1g on the other, the points 1g being situated between the points 1f. This causes the line within the compressed portion 1b of the tube 1 to follow a zig-zag path and increases the friction between the line 2 and tube 1.

In FIG. 7d, the tube 1 is compressed by exerting forces on the wall of the tube at either end of the tube and perpendicular to one another. The end 1h of the tube 1 may be compressed more than the end 1i.

In FIG. 7e, the tube 1 is compressed from an uncompressed state (shown in dashed line) to a compressed state by exerting forces on two opposite sides of the tube wall to form two flats 5, 6 to the tube and compress the line 2 therein a predetermined distance to change its cross sectional shape whilst ensuring its cross sectional area and therefore tensile performance remains unchanged.

FIGS. 8 and 9 illustrate means to protect the line against damage resulting from the exertion of side forces on the line 2. In FIG. 8, the end 1j of the wall 1a of tube 1 is radiused. This may be achieved by swaging. The purpose of providing a radius on the end 1j is to avoid point loading of the line 2 which may compromise its integrity in the event that a force is exerted on the line 2 that is not aligned with the longitudinal axis of the tube.

In FIG. 9a, an internal bush 3 is inserted in the tube 1. The bush 3 is made from a plastics material. When the line 2 is subjected to a force that is not aligned with the longitudinal axis of the tube 1, the bush bends about the point 3a and therefore distributes the point load that would otherwise be exerted on the line 2 over a greater area.

In FIG. 9b, rather than providing a bush internally of the tube 1, the bush 4 is mounted externally of the tube 1. The bush 4 provides an enlarged end section 4a which the line engages with when a side force is exerted thereon, the end section 4a functioning to distribute the load on the line over a greater area and therefore reduce the risk of damage to the line. The bush 4 includes a step 4b which sits up against the end of the tube 1, and portion 4c which surrounds the tube.

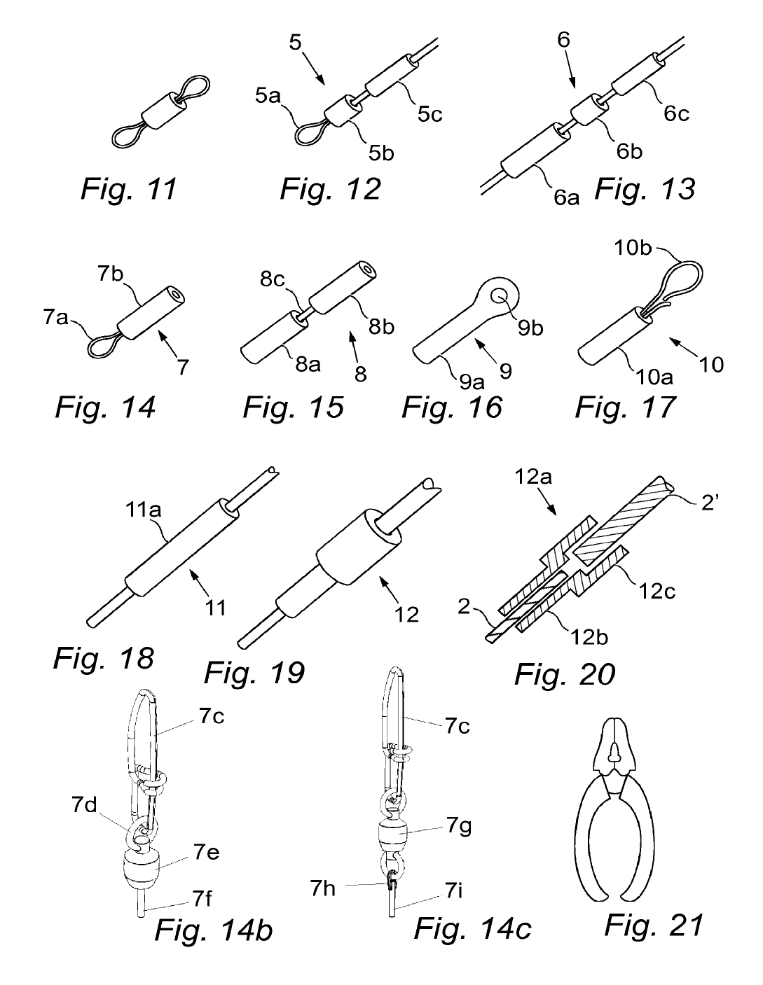

FIGS. 11 to 20 illustrate items of fishing tackle. FIG. 11 is an example of a swivel of the prior art. FIGS. 12 to 20 illustrate items of fishing tackle in accordance with the present invention.

FIG. 12 illustrates a swivel 5 comprising a loop 5a connected to one end of a swivel body 5b and a compressible connector 5c connected to the other end of the swivel body.

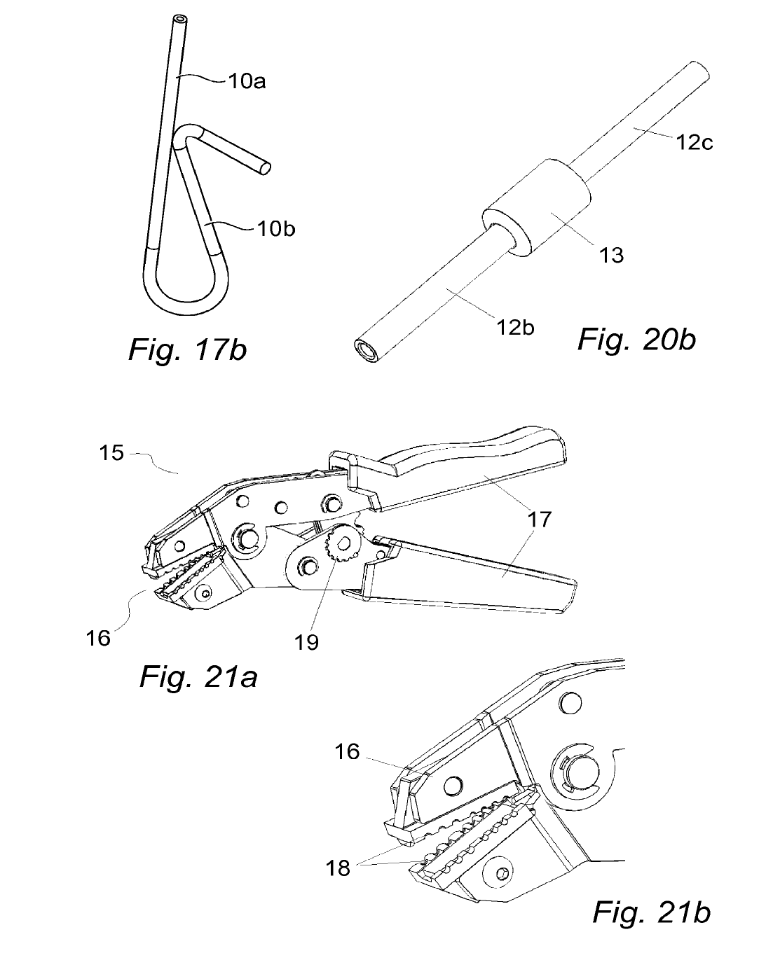

FIG. 13 illustrates a swivel 6 comprising compressible connectors 6a and 6c connected to a swivel body 6b. FIG. 14 illustrates a swivel 7 comprising a compressible connector 7b and a loop 7a mounted to rotate with respect thereto. Of course, the loop 7a may take the form of a wire, a loop, a ring, a clip, a snap shackle or a so-called ‘quicklink’ in a similar form to that shown in FIG. 17b, for example. The clip or loop 7a may comprise locking means to allow the swivel to be securely and removeably attached to one or more other items of fishing tackle. Alternatively, as shown in FIG. 14b, a clip 7c may be adapted to attach to the loop 7d of the swivel 7e wherein the swivel includes a compressible connector 7f for receiving a fishing line in accordance with the present invention. In a further embodiment, as shown in FIG. 14c, a known swivel 7g (as shown in FIG. 11), may be attached at one end to a clip 7c and at its other end to a loop or clip 7h of a connector having a compressible connector 7i (similar to the connector shown in FIG. 16 or 17).

FIG. 15 illustrates a swivel 8 comprising compressible connectors 8a, 8b which are rotatable relative to each other about shaft 8c.

FIG. 16 illustrates a connector 9 comprising a compressible connector 9a having an eye 9b at one end thereof.

FIG. 17 illustrates a connector 10 comprising a compressible connector 10 having a clip 10b extending from one end thereof. An angler may use such a clip to attach a swivel to for example. Of course, the clip 10b may take the form of a wire, loop, ring, snap shackle or a so-called ‘quick link’, as shown in FIG. 17b, which may be attached securely to the end of the mainline allowing for quick changes of rigs.

FIGS. 18 to 20 illustrate line connectors for connecting together two separate pieces of line in a coaxial and spaced manner.

The line connector 11 of FIG. 18 comprises a compressible connector 11a into which line 2, 2′ may be inserted from opposite ends. The compressible connector is compressed onto the line 2, 2′, thereby connecting the two pieces of line together in a coaxially aligned and spaced manner.

FIGS. 19 and 20 illustrate a line connector 12 configured to connect together two pieces of line of different diameter. The connector 12 comprises a compressible connector 12a including two line receiving portions 12b, 12c, each configured to receive line of a different diameter. Line 2 is inserted into the portion 12b, and the portion 12b is compressed thereby securing the connector 12 onto the line 2. Line 2′ is inserted into the portion 12c and compressed, thereby securing line 2′ to the connector 12, and joining the two pieces of line together. In a further embodiment, the portions 12b, 12c may be rotatably coupled by a swivel 13, as shown in FIG. 20b. The portions 12b, 12c may be adapted to each receive the same size line or different sized line in a similar manner to the connectors shown in FIGS. 18 and 19.

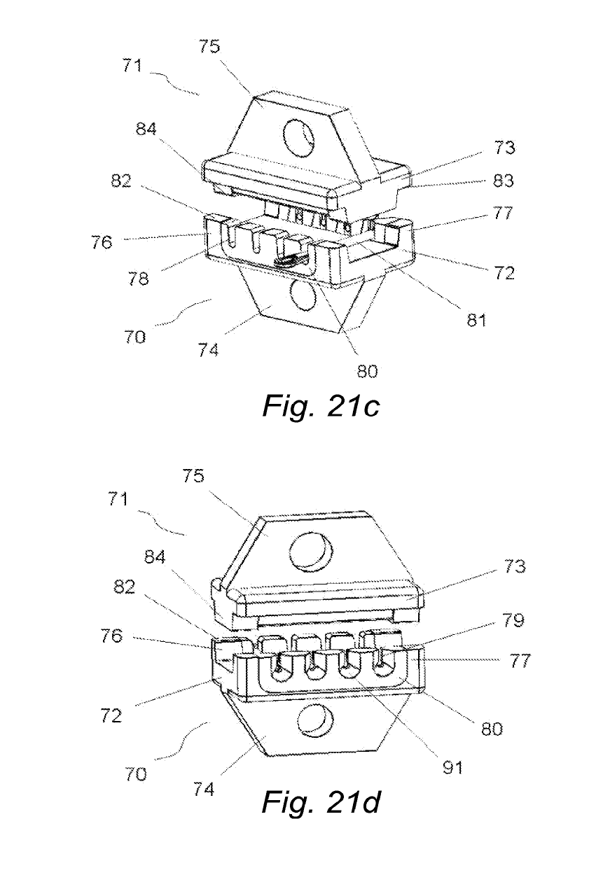

FIG. 21 illustrates a compression tool 15 suitable for use in compressing the compressible connector. The tool 15 desirably offers the user a mechanical advantage to compress the relatively strong compressible connector towards the line to be secured thereto. The tool 15 includes a pair of jaws 16 which are adapted to compress the compressible connector of the invention in a desired and controlled manner. For example, the jaws may be configured to compress the compressible connector in any one of the manners illustrated in FIGS. 7a to 7e. The tool 15 is adapted to compress the compressible connector of at least one item of fishing tackle, such as a hook, connector or swivel, in accordance with the present invention, in a single clamping operation. For example, a single hook may be clamped to a line in a single operation or two or more similar or different items of fishing tackle may be clamped to separate lines in a single clamping operation.

A preferred embodiment of the tool 15 is shown in FIGS. 21a and 21b. Each of the pair of jaws 16 has a plurality of different sized corresponding grooves 18 which are sized according to the diameter of line and/or the item of fishing tackle. The grooves 18 are laterally orientated relative to a longitudinal axis of each jaw. Each groove 18 is colour-coded for the angler's convenience.

Advantageously, when the jaws 16 of the tool are closed a gap of predetermined size exists between the jaws. This prevents the tool from over compressing the compressible connector and compromising the integrity of the line. This gap size is selected depending on the diameter and/or type of line being attached to the item of fishing tackle. The gap size required has been found to be directly proportional to the tube and line diameter being compressed. The jaws 16 are detachable and differently sized jaws may be selected and fitted to the tool according to the diameter of line being connected to the item of fishing tackle being clamped. The gap size conferred with a single pair of jaws when in a closed configuration may be adjustable instead of the gap size being determined by a selected pair of differently configured jaws. Selecting a predetermined gap size when the jaws are closed is a more desirable approach as opposed to selecting a predetermined clamping force because the risk of overloading and therefore over compressing a connector and line therein is prevented when the jaws are closed irrespective of the force being exerted thereon as the jaws are prevented from moving closer together.

A preferred embodiment of the jaws of the tool is shown in FIGS. 21c and 21d. Each of the jaws 70, 71 comprise a clamping portion 72, 73 for engaging an item of fishing tackle to be compressed in accordance with the present invention, such as a loop connector, and an attachment portion 74, 75 for attaching each jaw to the tool. The clamping portion 72 of the first jaw 70 comprises two spaced and parallel walls 76, 77 extending from the clamping portion towards the second jaw 71. Each wall 76, 77 comprises a plurality of equally spaced and corresponding slots or grooves 78, 79 each adapted to receive an item of fishing tackle in accordance with the present invention. As shown, one end of the item of fishing tackle engages in a groove of the first wall 76 and the other end engages in a corresponding groove of the second wall 77 so the item of fishing tackle is arranged substantially laterally across the jaws. Each groove comprises a curved base which is correspondingly sized with the compressible connector 81 of the item of fishing tackle.

The jaws are suitably made from a metal material, such as hardened steel. However, a portion 80 of the first wall 76 and/or second wall 77 is formed from a material having a relatively high coefficient of friction, such as rubber or plastic, to provide grip when an item of fishing tackle is placed in the first jaw. This ensures the item of fishing tackle does not slip from the first jaw before the item of fishing tackle is compressed in the jaws.

The upper open edges of the grooves 78 in the first wall 76 are curved to help guide an item of fishing tackle being inserted therein. The grooves 78 comprise a curved base which is complimentarily shaped with the compressible connector 81 of the item of fishing tackle to thereby support the same when received in the first jaw. The upper open edges of the grooves 79 in the second wall are closely spaced and are substantially right angled as opposed to being curved. The outer edges of the grooves 79 in the second wall are tapered inwardly to define a funnel portion 91 around the outer edge of each groove 79. Each funnel portion 91 helps to guide an end of fishing line being inserted into the compressible connector 81. This is particularly desirable for users with poor eyesight or working in difficult conditions such as when using the tool in cold weather when feeding an end of fishing line into the eye of a hook, for example, would be extremely difficult, particularly when wearing gloves.

The upper faces 82 of the first and second walls 76, 77 are substantially flat to mate with a substantially flat corresponding faces 83 of the clamping portion 73 of the second jaw 71. The projected part 84 of the clamping portion 73 of the second jaw 71 is suitably sized so that when the clamping faces 82, 83 are in a closed position and thereby engaged, a gap exists between the projected part 84 and the first jaw to prevent the tool from over compressing the compression connector 81 and compromising the integrity of the line. This gap size may be selectively adjustable depending on the diameter of line being attached to the item of fishing tackle.

Referring back to FIGS. 21a and 21b, the jaws 16 are angled relative to handle portions 17 for ease of use of the tool. The tool 15 has grips suitable for use by right- and left-handed fishermen.

The tool 15 includes a ratchet mechanism 19 to allow the gap size between the jaws when in a closed configuration to be selectively adjusted and to ensure the correct clamping force is applied during every clamping operation. Alternatively or additionally, the ratchet mechanism 19 may be adapted to adjust the clamping force applied to the connector and line.

One of the advantages of the tool 15 is that the item of fishing tackle can be held in the tool whilst the fisherman attempts to insert the line into the compressible connector. It is much easier to hold a larger object like a hand tool, than it is to hold a tiny item of fishing tackle such as a hook.

Firstly, the handle portions 17 are moved towards each other to move the jaws towards a closed position to hold an item of fishing tackle in accordance with the present invention therebetween. After the line is inserted into the compressible connector of an item of fishing tackle in accordance with the present invention, the handle portions 17 are further moved together by the operator to move the jaws 16 towards the closed position thereby to compress and inelastically deform the compressible connector of the item of fishing tackle and securely attach the same to the line therein without compromising the integrity of the line. The ratchet mechanism 19 ensures sufficient clamping force is applied to the line and connector during the clamping operation. On further movement of the handle portions 17 towards each other, the ratchet mechanism 19 is released and the jaws 16 open to release the item of fishing tackle now securely attached to the line.

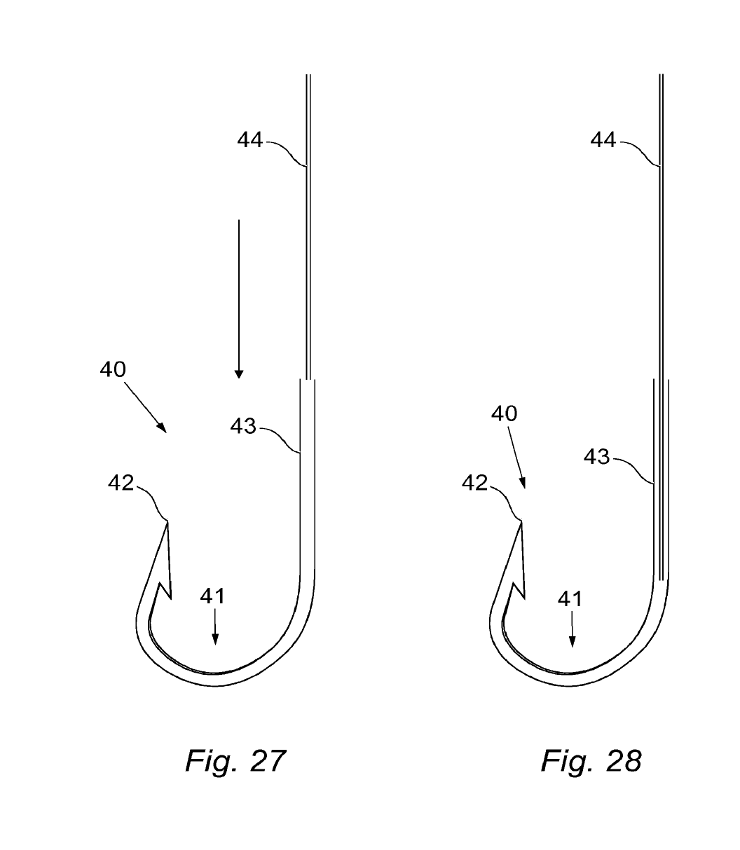

FIGS. 27 and 28 illustrate another embodiment of a hook according to the invention where the hook 40 is comprised of a single element which includes a bend 41 that may be substantially solid, and a shank 43 that is hollow. The bend 41 presents a point 42 at one end with the shank 43 extending from the other end. In use the fisherman inserts the line 44 into the hollow shank 43 and when the line 44 is fully inserted, the wall of the shank 43 is compressed such that the line is gripped and the hook is secured to the line.

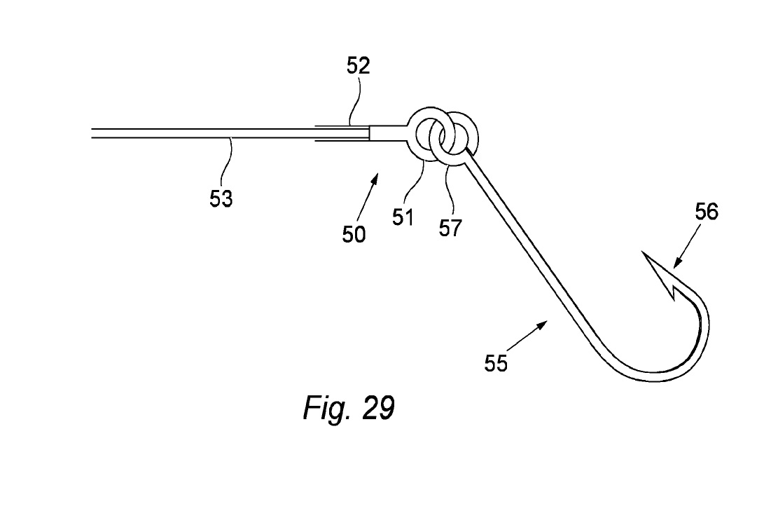

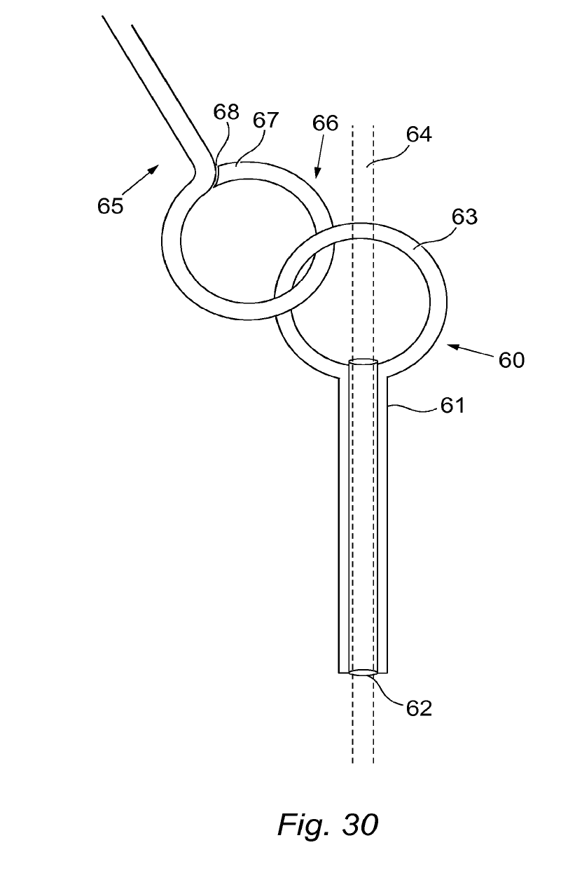

Referring now to FIG. 29 there is illustrated a connector 50 having an eye 51 and a compressible tube 52 adapted to receive a fishing line 53. As can be seen the connector 50 is attached to a fishing hook 55 comprising a point 56 and an eye 57. The eyes 51 of the connector 50 and 57 of the hook 55 interlock, and in the illustrated embodiment these two components are assembled during in manufacture. However, one of the respective eyes 51, 57 may be formed in the manner illustrated in the embodiment illustrated in FIG. 30, with one or both of the eyes 51, 57 formed by bending the wire from which the component is formed to leave a gap 68 such that the eye of the other component may be inserted through the gap 68 such that the eyes interlock. The gap 68 may then be closed by squeezing the eye with a suitable tool. The hook 55 and connector 50 may be sold pre-assembled or may be sold separately.

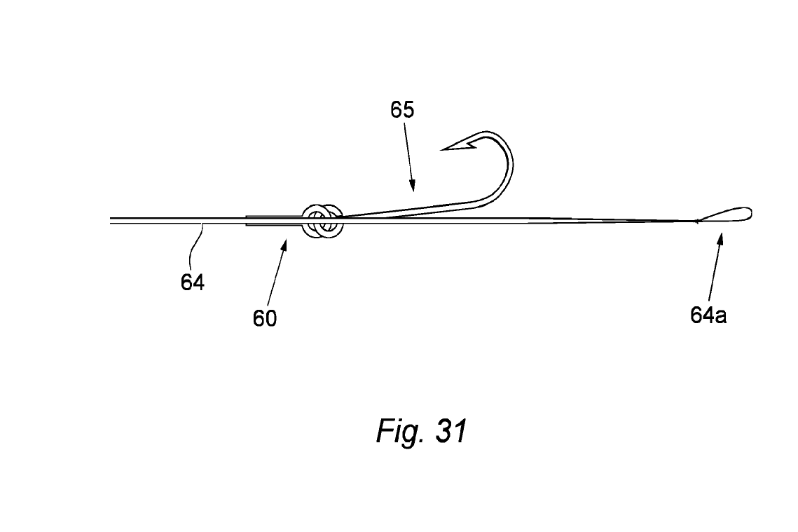

Referring now to FIGS. 30 and 31, the connector 65 includes a compressible tube 61, the bore 62 of which extends through the wall of eye 63. The eye 63 may be attached to the tube 61 by suitable means, such as laser welding, for example. The advantage of this arrangement is that the line 64 may be passed through the bore 62 and extend beyond the hook 65, (see part 64a of the line 64 in FIG. 31), and the amount of line extending beyond the hook 65 adjusted to the requirement of the angler. Therefore, the connector may be attached to the end of the line or a distance from the end if desired. This also desirably allows multiple connectors to be attached to a single piece of line making them ideal for rig manufacture and multi link terminal tackle set ups, which is particularly desirable to lure anglers as the small solid eye is suitable for attaching lures that feature split rings. The tube 61 also allows for the line to be passed across the back of the hook shank so that a ‘hair’ can be made. Furthermore, more than one hook may connect to a single connector. The eye 63 of the connector may be slender in shape rather than being substantially circular as shown in the Figures. A slender shape would desirably reduce the risk of collecting weed and/or debris which would otherwise require the line to be wound in for the weed and/or debris to be removed resulting in an undesirable interruption to fishing time. Of course, the eye 63 may take the form of a wire, a loop, a ring, a clip, a snap shackle or so-called ‘quicklink’, for example.

Hooks typically go through a number of tempering processes which can make the material from which they are made unsuitable for compressing onto the line. By making the connector a separate but linked component the material properties of the connector may be selected to be the most appropriate for compression on to a line. Also, since different types of line, be that different strengths of line or line from different manufacturers, have different diameters. By fabricating the connector as a separate component different diameter bores can be provided without having to change the manufacture of the hook. Also, because the physical requirements of the hook do not need to be addressed in the specification of the connector, it may be possible to manufacture the connector from cheaper materials and in a less costly manner.

As can be appreciated from FIG. 30, the eye of one of the hook and connector (the hook in the case of the embodiment of FIG. 30), is formed by bending a piece of wire. The eye 66 is formed so as to leave an end 67 that is spaced slightly from the adjacent part of the hook, leaving a gap 68. The hook 66 may therefore be manufactured and sold as a separate item to the connector 60. To attach the hook to the connector, the angler passes the eye of the connector 60 through the gap 68 and then closes the gap by squeezing the wire from which the eye 66 is formed with a suitable tool. In this way the angler can use the connector 60 with a wide range of hooks. Of course, it could be the eye of the connector that includes the gap, in which case the hook may or may not be constructed in the manner illustrated in FIG. 30.

Of course, the connector 60 can be used with other items of fishing tackle having an eye other than a hook, such as a known swivel as shown in FIG. 11 or a swivel in accordance with the present invention as shown in FIGS. 12 and 14 for example. Furthermore, the connector 60 may connect with another connector such as shown in FIGS. 16 and 17, for example. The connectors 16, 17, 60 may be sized accordingly to accommodate a certain diameter and/or length of line in the compression compressible connector 9a, 10a, 61. Connectors of the same or different size may be connected together as described above.

### EXAMPLES

One of the objects of the invention is to provide a means of attaching an item of fishing tackle to a line which gives a stronger connection than a knot.

In order to establish this, a number of mechanical tests were conducted:

### Test 1—Tensile Test to Compare Compressed Line Against Knot

A length of cold drawn stainless steel tube with the following dimensions: 1.59 mm outside diameter, 1.19 mm inside diameter, 0.2 mm wall and 15 mm length was prepared in the following way:
i) Heating until cherry red for approximately 10 seconds and then cooling rapidly in water. This was repeated three times;
ii) A piece of nylon fishing line diameter 0.26 mm distributed as Preston Reflo Powerline™ was passed through the tube;
iii) The tube was then compressed on to the nylon line using a pair of pliers and reasonable force to compress and trap the line. The tube was not compressed along the entire length but a minor section of the tube was left uncompressed in order to prevent the end of the tube cutting into the line;
iv) The emerging length of line was then tied to a fishing hook approximately 200 mm from the tube using a half blood tucked knot with five rotations of line;
v) The tube was then placed in a vice which was tightened enough to hold the tube but not deform it further; and
vi) The hook was then gripped using a pair of pliers and the line was loaded slowly by hand in-line with the tube until failure of the line occurred.

It was noted that the line failed at the point of the knot whilst it remained intact at the end of the tube. Test 1 demonstrates that securing fishing line in a tube using compression is stronger than the commonly used method of tying a half blood tucked knot with five rotations of line.

To reinforce these results, five tensile tests were performed on each of a nylon line having an actual diameter of 0.205 mm attached to a compression tube as described above and the same type of line knotted to a hook. Table 1 below shows the results of the tensile tests indicating the breaking strain of the line in lbs. It can be seen that the breaking strain required to break the line attached to the tube in accordance with the present invention is higher and therefore stronger than the line knotted to a hook.

TABLE 1

| | Nylon line attached in | Nylon line attached to |
|---|---|---|
| Sample | compression tube | hook by spade knot |
| 1 | 6.01 | 4.59 |
| 2 | 6.16 | 5.38 |
| 3 | 5.31 | 4.87 |
| 4 | 5.9 | 5.7 |
| 5 | 6.1 | 3.78 |

### Test 2—Tensile Test for Compressed Line

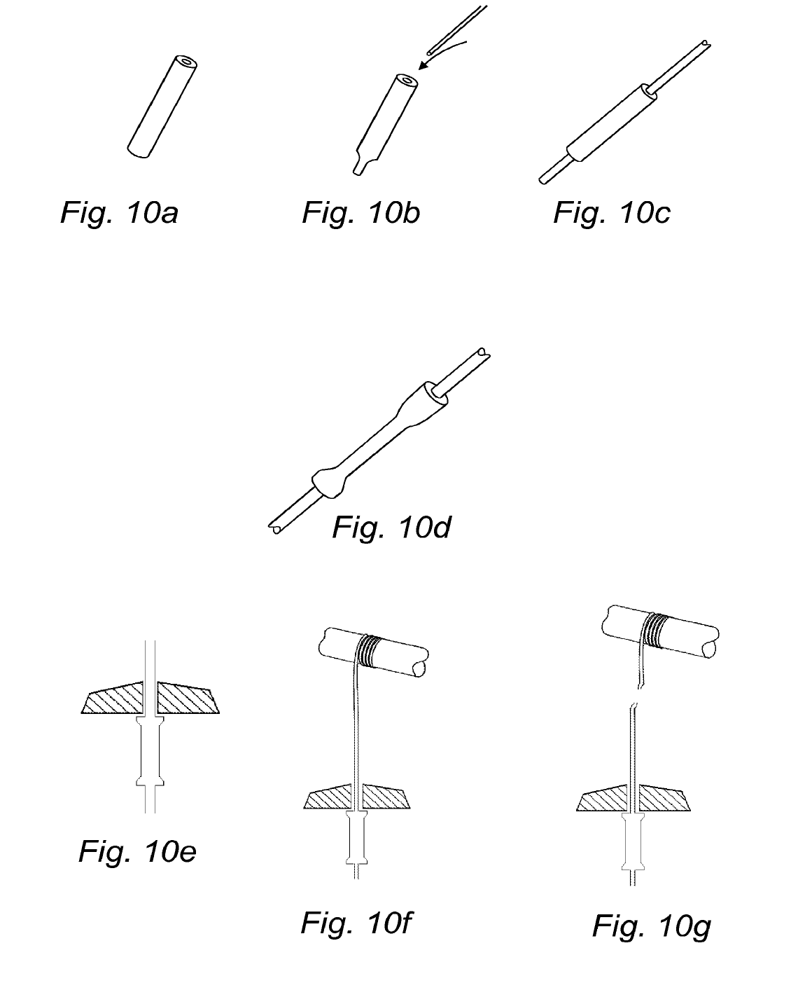

A length of gauge 19 cold drawn stainless steel tube with the following dimensions: 1.10 mm outside diameter, 0.685 mm inside diameter, 0.208 mm wall thickness, 15 mm length was prepared in the following way to grip a piece of Mitchel Universe™ 0.22 mm, 3,900 Kg nylon fishing line. The test is illustrated in FIGS. 10a to 10g.
i) Heating the tube until cherry red for approximately 10 seconds then cooling rapidly in water, repeated three times;
ii) An end of line was inserted into the tube (FIG. 10b);
iii) The line was pulled through the tube (FIG. 10c);
iv) The tube was compressed a predetermined distance over a major length to compress the line therein without compromising its integrity whilst leaving uncompressed tube end portions (see FIG. 10d);
v) The tube was constrained below the jaws of a vice without compressing the line (see FIG. 10e);
vi) The other end of the line was wrapped approximately four times around a 24 mm diameter soft rubber handle of a mallet to provide friction and prevent high stress in the area (see FIG. 10f); and
vii) The line was pulled slowly to failure (see FIG. 10g).

The line failed in between the tube and the handle leaving a length of approximately 40 mm unbroken line protruding from the tube.

This test shows that it is possible to grip 0.23 mm diameter nylon fishing line in a 1.10 outside diameter and 0.685 inside diameter stainless steel tube using a knot, strong liquid adhesive and compression with a retention strength equal to 100% of the line strength. This demonstrates that if tackle is joined to a line using this method then the weakest part of the resulting equipment is the line.

Additional tests were performed with different line sizes (0.19 to 0.305 mm diameter Reflo Powerline™ and 0.47 to 0.69 mm diameter Mustad Snood Mono Clear™ and tubes and without adhesive:

1. A tube outer diameter of 1.1 mm and wall thickness of 0.208 mm was sufficiently thick to provide a frictional force almost equal to (96.29%) the tensile strength for the largest line tested (0.305 mm diameter Preston Reflo Powerline™) which failed at an average force of 14.72 lb.

It was found that for the outer diameter of 1.1 mm tube when tested with the 0.19 to 0.305 mm diameter Reflo Powerline™ the optimal jaw gap was linearly related to the line diameter. It was also found that the tightest acceptable tolerance for the jaw gap was +/−0.015 mm

For the 1.1 mm outer diameter tubes when used with the 0.19 to 0.305 mm diameter Preston Reflo Powerline™ it was found that the minimum jaw/crimp length was 6 mm.

2. A tube outer diameter of 1.3 mm and wall thickness of 0.305 mm was sufficiently thick to provide a frictional force almost equal to (96.38%) the tensile strength of 0.575 mm diameter (30 lb) Mustad Snood Mono™ which failed at an average force of 42.3 lb

It was found that for the outer diameter of 1.3 mm tube when tested with the 0.47 to 0.69 mm diameter Mustad Snood Mono Clear™ the optimal jaw gap was linearly related to the line diameter. It was found that the tightest acceptable tolerance for the jaw gap was +/−0.02 mm

When the 15 to 30 lb Mustad Snood Mono™ line was tested it was found that the jaw/crimp length needed to be increased to 10 mm to maintain performance.

The affect of water being present was tested by submerging the line before and after joining the line and tube. The line and tube were soaked for 14 hours following joining. No detrimental affect was seen to the strength of the line retention.

### Mechanical Testing Conclusions

The wall thickness of the tube is a function of the tube initial inner and outer diameters. As the tube inner diameter is driven by the line size the tube outer diameter was varied to give the optimum wall thickness. The wall thickness is determined by the following factors:
Stiffness required to resist distortion of the compressed area as the line is loaded in tension;
Stiffness to resist bending of the compressed area; and
Softness to allow compression using a suitable compression tool

The gap between the jaws at the completion of the compression cycle is a critical factor in the performance of the line/tube interface. Under ideal operational conditions, the line would be compressed to the smallest size that will not compromise tensile strength. It is believed that the line is soft enough that the cross-sectional area does not reduce during compression but instead changes shape from substantially round to flattened round. This means that the tensile strength of the line remains constant but the frictional force between the line and the tube increases the more the line is compressed. This relationship holds true until the line is compressed so much that the cross-sectional area is reduced and the tensile strength of the line is also reduced.

Annealed Stainless Steel 316 was selected as a suitable material for the application due to its high resistance to corrosion, resistance to bending, softness and good homogeniality for compression.

At the line/tube interface, the magnitude of the surface area subject to the load must be large enough that line material shear limit is not exceeded. Since the diameter of the line is predetermined, the area of line/tube interface is increased by increasing the jaw/crimp length.

Due to the nature of the environment in which the present invention will be used, is was necessary to test the affect of water being present within the tube both during and following the joining or compression process.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An item of fishing tackle comprising:
a hook having a bend with a first end and a second end, the first end comprising a point;
a compressible connector disposed at the second end of the bend to create a shank, the shank being adapted to attach the item of fishing tackle to a single linear fishing line, the shank comprising a wall defining an elongate cavity having an opening at a first end thereof, the cavity being adapted to receive a portion of single linear fishing line through the opening, and the wall being adapted to be compressed inelastically towards the portion of fishing line inserted into the cavity to secure the portion of line therein; and
a bush element disposed the first end of the compressible connector, the bush element being adapted to distribute lateral forces exerted on the fishing line.

2. An item of fishing tackle according to claim 1, wherein the shank and the bend are integrally formed.

3. An item of fishing tackle according to claim 1, wherein one of the shank and the bend includes a spigot and the other includes a spigot receiving portion, and wherein the bend is secured to the shank by inserting the spigot into the spigot receiving portion.

4. An item of fishing tackle according to claim 3, wherein the spigot and spigot receiving portion include correspondingly shaped elements configured to restrict relative movement between the spigot and spigot receiving portion.

5. An item of fishing tackle according to claim 4, wherein the spigot and the spigot receiving portion are joined together with at least one of an interference fit, weld, or butt joint.

6. An item of fishing tackle according to claim 1, wherein the bush comprises a radius on an edge of the wall presented at the opening.

7. An item of fishing tackle according to claim 6, wherein the bush sits externally of wall.

8. An item of fishing tackle according to claim 6, wherein a part of the bush extends beyond an end of the opening.

9. An item of fishing tackle according to claim 6, wherein the bush comprises an enlarged, rounded end section for distributing lateral forces exerted on the fishing line.

10. An item of fishing tackle comprising:
a hook having a bend with a first end and a second end, the first end comprising a point;
a compressible connector disposed at the second end of the bend, the compressible connector being adapted to attach the item of fishing tackle to a fishing line, the compressible connector comprising a wall defining an elongate cavity having an opening at a first end thereof, the cavity being adapted to receive a portion of fishing line through the opening, and the wall being adapted to be compressed inelastically towards the portion of fishing line inserted into the cavity to secure the portion of line therein; and
a force distribution element disposed the first end of the compressible connector, the force distribution element being adapted to distribute lateral forces exerted on the fishing line, the force distribution element comprising a bush sitting externally of the wall of the connector and comprising an end portion that extends partially or fully over the edge of the wall presented at the opening of the cavity, thereby providing a radius on the edge of the wall presented at the opening.

11. An item of fishing tackle according to claim 10, wherein the bush is selectively connectable to the compressible connector.

12. An item of fishing tackle comprising:
a force distribution element that is adapted to be associated with another item of fishing tackle to distribute lateral forces exerted on a fishing line connected to the other item of fishing tackle, the force distribution element comprising a bush having: (i) an enlarged, rounded end section for distributing lateral forces exerted on the fishing line, (ii) an internal step that is positionable against an end of the other item of fishing tackle, and (iii) a sleeve portion that surrounds the end of the other item of fishing tackle.

13. An item of fishing tackle according to claim 12, wherein the bush is formed of an elastically deformable material.

14. An item of fishing tackle according to claim 12, wherein an internal radius of the enlarged, rounded end section increases from a first internal radius adjacent the internal step to a second, larger internal radius adjacent an end of the bush.
